(19) United States
(12) Patent Application Publication
(10) Pub. No.: US 2006/0158033 A1
(43) Pub. Date: Jul. 20, 2006

(54) Brake fluid pressure control apparatus and method

(75) Inventors: Masayasu Ohkubo, Okazaki-shi (JP); Yoshito Tanaka, Nishikamo-gun (JP); Hiroshi Nakaoka, Okazaki-shi (JP); Masaaki Komazawa, Nishikamo-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/319,390

(22) Filed: Dec. 29, 2005

(30) Foreign Application Priority Data
Jan. 20, 2005 (JP) 2005-013064

(51) Int. Cl. B60T 8/32

(52) U.S. Cl. 303/191; 303/163

(57) ABSTRACT

A brake fluid pressure control apparatus of a vehicle includes a hydraulic brake in which the fluid pressure of a brake cylinder for a wheel is controlled so as to retard the rotation of the wheel, and a hydraulic actuator capable of controlling the fluid pressure of the brake cylinder. An actuator controller feedback-controls the hydraulic actuator so that the actual fluid pressure of the brake cylinder approaches a target fluid pressure determined in accordance with a braking requirement. The actuator controller determines a control gain used when determining a control command value to be sent to the hydraulic actuator, based on at least one of the temperature of a working fluid and a slipping state of the wheel.

### INCORPORATION BY REFERENCE

The disclosure of Japanese Patent Application No. 2005-13064 filed on Jan. 20, 2005, including the specification, drawings and abstract, is incorporated herein by reference in its entirety.

### BACKGROUND OF THE INVENTION

1. Field of the Invention

The invention relates to determination of control gains in a brake fluid pressure control.

2. Description of Related Art

Japanese Laid-open Patent Publication No. JP-A-2000-62595 discloses determination of a control gain based on the fluid pressure of a brake cylinder for each wheel of the vehicle or a difference between the pressures sensed on the upstream and downstream sides of a hydraulic valve(s) capable of controlling the brake cylinder pressure. Japanese Laid-open Patent Publication No. JP-A-2002-2462 discloses determination of a control gain based on a difference between the target deceleration and the actual deceleration or the speed of operation of a braking member.

### SUMMARY OF THE INVENTION

It is an object of the invention to provide a brake fluid pressure control apparatus and a brake fluid pressure control method in which a control gain used for determining a control command value to a hydraulic actuator is set to an appropriate value.

To accomplish the above and/or other object(s), there is provided according to one aspect of the invention a brake fluid pressure control apparatus of a vehicle which includes: (a) a hydraulic brake having a brake cylinder for a wheel, the brake cylinder having a fluid pressure that is controlled so as to retard the rotation of the wheel, (b) a hydraulic actuator capable of controlling the fluid pressure of the brake cylinder, and (c) an actuator controller that feedback-controls the hydraulic actuator so that an actual fluid pressure of the brake cylinder approaches a target fluid pressure determined in accordance with a braking requirement. In the brake fluid pressure control apparatus, the actuator controller includes a control gain determining unit that determines a control gain used when determining a control command value to be sent to the hydraulic actuator, based on at least one of the temperature of working fluid and the slipping state of the wheel.

In the brake fluid pressure control apparatus according to the above-described one aspect of the invention, the hydraulic actuator is controlled according to the control command value so that the actual brake cylinder pressure approaches the target fluid pressure. The control gain used when determining the control command value to be sent to the hydraulic actuator is determined based on at least one of the temperature of the working fluid and the slipping state of the wheel.

When the temperature of the working fluid is low, for example, the viscosity of the working fluid is high, and a delay in control of the brake cylinder pressure increases accordingly. It is therefore desirable to determine the control gain such that a value of the control gain determined when the temperature of the working fluid is low is larger than that of the control gain determined when the temperature of the working fluid is high. It is further desirable to determine the control gain such that a value of the control gain determined when the temperature of the working fluid is equal to or lower than a reference level is larger than that of the control gain determined when the temperature of the working fluid is larger than the reference level. For example, when the temperature of the working fluid is equal to or lower than a set temperature (a threshold temperature) at which a control delay due to an increased viscosity of the working fluid becomes undesirably large, the value of the control gain is made larger than that of the control gain determined when the working fluid temperature is higher than the set temperature. With this arrangement, the control delay produced due to the low temperature of the working fluid can be reduced.

The brake fluid pressure control apparatus may perform slip control when the slipping state of a wheel becomes excessively large in relation to the coefficient of friction of a road surface on which the vehicle is running. The control apparatus of this type is required to exhibit a high response during the slip control. To achieve a high response, it is desirable to determine the control gain such that a value of the control gain determined when slip control is being performed on the wheel is larger than that of the control gain determined when no slip control is being performed on the wheel. In other words, the control gain is determined such that a value of the control gain determined when the wheel is in a slipping state that requires slip control to be performed is larger than that of the control gain determined when the wheel is not in such a slipping state. With this arrangement, the response can be enhanced during slip control. The slip control is in the form of several types of controls, which include, for example, anti-lock control with which the brake cylinder pressure is controlled so that the slipping state of a wheel to which a brake is being applied becomes the optimum state relative to the coefficient of friction of the road surface, traction control with which the brake cylinder pressure is controlled so that the slipping state of a wheel that is being driven becomes the optimum state, and vehicle stability control with which the brake cylinder pressure is controlled so that the lateral slipping state of a wheel becomes the optimum state. The brake fluid pressure control apparatus to which the invention is applied is capable of performing at least one of the above-indicated controls, and the control gain is set to a larger value during implementation of at least one of the controls that can be performed by the control apparatus.

The hydraulic actuator as indicated above may include a solenoid of an electromagnetic, hydraulic valve capable of controlling the fluid pressure of the brake cylinder, or may include an electric motor that drives a hydraulic pump. In operation, electric current applied to a coil of the solenoid or electric current passing through the electric motor is controlled so as to control the fluid pressure of the brake cylinder.

In one embodiment of the invention, the actuator controller further includes an operation-dependent control gain determining unit that determines the control gain based on the state of the operation of a braking member by the vehicle operator. For example, the control gain may be determined such that a value of the control gain determined when an operating force as the state of the operation of the braking member is large is smaller than that of the control gain determined when the operating force is small, and the control gain is determined such that a value of the control gain determined when an operating speed as the state of the operation of the braking member is high is smaller than that of the control gain determined when the operating speed is low. It is further desirable to determine the control gain such that a value of the control gain determined when the operating force as the state of the operation of the braking member is equal to or larger than a reference force is smaller than that of the control gain determined when the operating force is smaller than the reference force, and such that a value of the control gain determined when the operating speed as the state of the operation of the braking member is equal to or higher than a reference speed is smaller than that of the control gain determined when the operating speed is lower than the reference speed. As stated above, the control command value to be sent to the hydraulic actuator is determined so that the actual value of the brake cylinder pressure approaches the target value. In the brake fluid pressure control apparatus according to this embodiment of the invention, the target value is determined based on the state of the operation of the braking member.

In the meantime, the behavior of the vehicle at the time of apply of a brake may differ, depending upon whether the suspension of the vehicle is supple or stiff, even with the same response (e.g., the same control gains) of the brake cylinder pressure. In the vehicle having a supple suspension, the speed of movement of the load is lower and the vehicle posture is subject to larger changes (vibrations having larger amplitudes are generated), as compared with those of the vehicle having a stiff suspension. These phenomena are particularly noticeable for the vehicle to which a relatively large braking force, in view of the suppleness of the suspension, is applied.

In a vehicle with a supple suspension, for example, when the operating force of the braking member is increased while the operating force is large, the front wheels are likely to slip by an excessively large degree due to a delay in the movement of the load toward the front wheels. If the control gain is reduced when there is a high possibility of excessively large slip (for example, when the operating force of the braking member is large), the actual brake cylinder pressure can be increased at a reduced rate, and the time at which the degree of slip becomes excessively large with respect to the coefficient of friction of the road surface can be delayed. The control gain may also be reduced when the operating force of the braking member is large AND the speed of the operation of the braking member (in a direction in which the operating force increases) is high.

When a brake is applied to a vehicle having a large empty vehicle weight (which is larger than a set weight), in particular, the posture of the vehicle is likely to change largely, and large noise may be produced due to the large change in the vehicle posture (e.g., squatting on the side of the front wheels). If the control gain is made smaller when the speed of the operation of the braking member (in a direction in which the operating force increases) is large, than that in the case where the speed of the braking operation is small, it is possible to reduce the rate of increase (speed of increase) of the brake cylinder pressure, suppress vibrations, and reduce or eliminate the noise produced due to a change in the vehicle posture.

The state of the operation of the braking member may be represented by the operating force applied to the braking member, stroke of the braking member operated, and N-time differential values of the operating force and stroke (where N is natural number equal to or greater than 1, the differential values being equivalent to the rate of change thereof, the acceleration of change thereof, and the like). The state of the operation of the braking member may also be represented by physical quantities that change with changes in the operating force applied to the braking member, the stroke of the braking member operated, and so forth. The operating force, stroke and the physical quantities as described above may be generally called “operation-associated quantities”. The above-described physical quantities may include, for example, the fluid pressure of a master cylinder, the fluid pressure of the brake cylinder, the amount by which a stroke simulator is operated, and so forth. For example, the state of the operation of the braking member may be acquired based on a detected value of a braking force sensor or a stroke sensor, or may be acquired based on a detected value of a master cylinder pressure sensor or a brake cylinder pressure sensor.

The hydraulic brake system including the control gain determining unit that determines the control gain based on the state of the operation of the braking member is not necessarily applied to all types of vehicles. More specifically, the hydraulic brake system of this type may be applied to vehicles of a type that has a supple suspension and is able to provide a relatively large braking force in response to the same brake cylinder pressure, but may not be applied to vehicles of a type having a stiff suspension or vehicles of a type that is not able to provide large braking force. In this connection, vehicles of a type whose damping coefficient is larger than a set value in standard conditions, for example, may be classified as the above type of vehicles having a stiff suspension, and vehicles of a type whose damping coefficient is equal to or smaller than the set value may be classified as the above type of vehicles having a supple suspension. Also, vehicles of a type in which the diameter of the brake cylinder is larger than a set value may be classified as the above type of vehicles capable of providing a relatively large braking force in response to the same brake cylinder pressure, and vehicles of a type in which the diameter of the brake cylinder is equal to or smaller than the set value may be classified as the above type of vehicles that is not able to provide large braking force. The stiffness of the suspension may also be evaluated on the basis of the degree of stiffness against pitching or rolling.

In a vehicle of a type in which its suspension can be switched between a stiff condition and a supple condition, the process of determination of the control gain may be changed depending upon whether the suspension is stiff or supple. For example, when the suspension is in a supple condition, the control gain is determined based on the state of the operation of the braking member.

To accomplish the above and/or other object(s), there is provided according to another aspect of the invention a brake fluid pressure control method of a vehicle which includes: (a) a hydraulic brake having a brake cylinder for a wheel, the brake cylinder having a fluid pressure that is controlled so as to retard the rotation of the wheel, (b) a hydraulic actuator capable of controlling the fluid pressure of the brake cylinder. In the brake fluid pressure control method, the hydraulic actuator is feedback-controlled so that an actual fluid pressure of the brake cylinder approaches a target fluid pressure determined in accordance with a braking requirement, and a control gain used when determining a control command value to be sent to the hydraulic actuator, is determined based on at least one of the temperature of working fluid and the slipping state of the wheel.

### BRIEF DESCRIPTION OF THE DRAWINGS

The foregoing and/or further objects, features and advantages of the invention will become more apparent from the following description of exemplary embodiments with reference to the accompanying drawings, in which like numerals are used to represent like elements and wherein:

FIG. 1 is a view schematically showing the operation of a brake fluid pressure control apparatus as an exemplary embodiment of the invention.

FIG. 2 is a circuit diagram of a hydraulic brake system including the brake fluid pressure control apparatus of FIG. 1.

FIG. 3 is a cross-sectional view of an electromagnetic, hydraulic valve of normally-open type, which is included in the brake fluid pressure control apparatus.

FIG. 4 is a cross-sectional view of an electromagnetic, hydraulic valve of normally-closed type, which is included in the brake fluid pressure control apparatus.

FIG. 5 is a flow chart illustrating a fluid pressure control program stored in a memory unit of a brake ECU of the brake fluid pressure control apparatus.

FIG. 6 is a flow chart illustrating an anti-lock control program stored in the memory unit of the brake ECU.

FIG. 7 is a flow chart illustrating a part of the fluid pressure control program of FIG. 5.

FIG. 8 is a map illustrating a table for determining a control gain, which table is stored in the memory unit of the brake ECU.

FIG. 9 is a view showing a brake fluid pressure control apparatus as another embodiment of the invention and its surroundings.

FIG. 10 is a flow chart illustrating a damping characteristic determination program stored in a memory unit of a suspension ECU connected to the brake fluid pressure control apparatus of FIG. 9.

FIG. 11 is a flow chart illustrating a part of a fluid pressure control program stored in a memory unit of a brake ECU of the brake fluid pressure control apparatus of FIG. 9.

### DETAILED DESCRIPTION OF EXEMPLARY EMBODIMENTS

A hydraulic brake system of a motor vehicle having a brake fluid pressure control apparatus as an exemplary embodiment of the invention will be described with reference to the drawings. The vehicle on which the hydraulic brake system of this embodiment is installed has a relatively large empty vehicle weight (and, therefore, large braking force appears in the vehicle), and has a relatively supple or soft suspension.

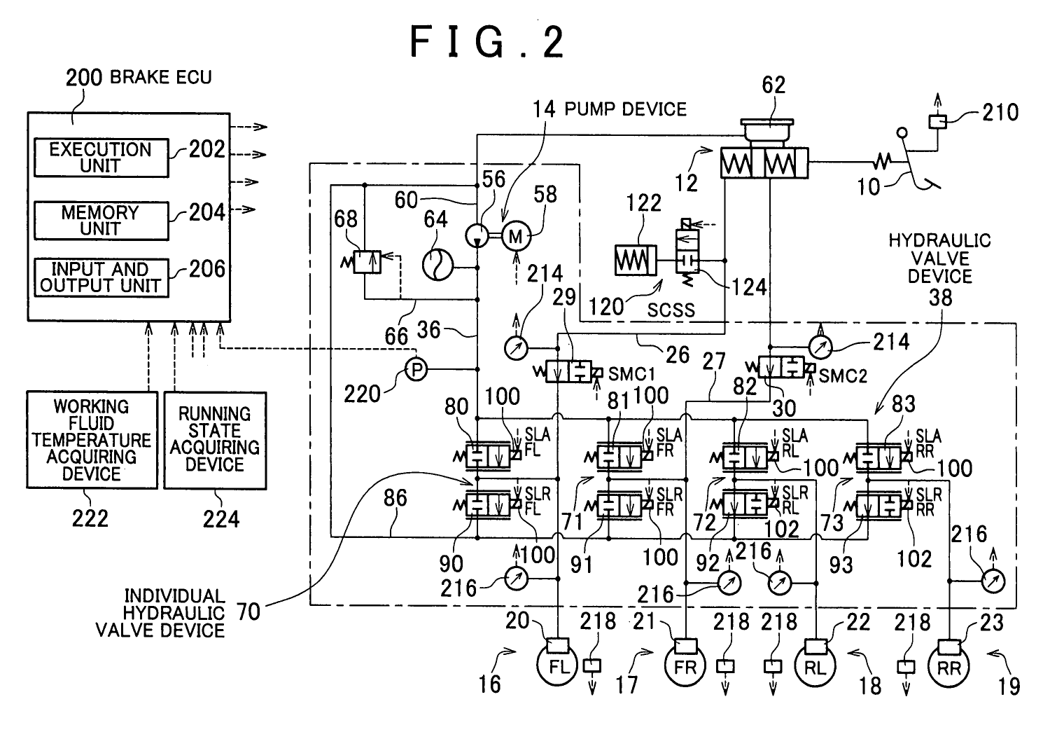

Referring to FIG. 2, the hydraulic brake system includes a brake pedal 10 that serves as a braking member, a master cylinder 12 having two pressure chambers, a pump device 14 that serves as a fluid pressure source operable by power, and hydraulic brakes 16, 17, 18, 19 provided for the respective wheels located on the front-left, front-right, rear-left and rear-right sides of the vehicle. The hydraulic brakes 16-19 are adapted to be operated by fluid pressures of brake cylinders 20, 21, 22, 23, respectively.

The master cylinder 12 includes two pressure pistons, and the pressure chambers are located ahead of the respective pistons. In operation, fluid pressures are generated in the pressure chambers in accordance with the operating force applied to the brake pedal 10 by the vehicle operator or driver. The two pressure chambers of the master cylinder 12 are respectively connected, via master lines 26, 27, to the brake cylinders 20, 21 of the hydraulic brakes 16, 17 for the front-left and front-right wheels. Master shutoff valves 29, 30 are provided in the master lines 26, 27, respectively. The master shutoff valves 29, 30 are solenoid-operated valves of normally open type.

The brake cylinders 20, 21, 22, 23 for the four wheels are connected to the pump device 14 via a pump line 36. In operation, fluid pressures are supplied from the pump device 14 to the brake cylinders 20-23 so as to operate the hydraulic brakes 16-19, under a condition that the brake cylinders 20, 21 for the front, left and right wheels are shut off from the master cylinder 12. The fluid pressures of the brake cylinders 20-23 are controlled by a hydraulic valve device 38 (which will be described later).

The pump device 14 includes a pump 56, and a pump motor 58 for driving the pump 56. A master reservoir 62 is connected to the inlet of the pump 56 via an intake line 60, and an accumulator 64 is connected to the outlet of the pump 56. In operation, working fluid contained in the reservoir 62 is pumped up by the pump 56, and is supplied to the accumulator 64 in which the fluid is stored under pressure. A relief line 66 is provided for connecting the pump line 36 on the outlet side of the pump 56 and the intake line 60 on the inlet side of the pump 56, and a relief valve 68 is provided in the relief line 66. The relief valve 68 is switched from a closed state to an open state when the fluid pressure sensed on the high-pressure side of the pump 56, i.e., on the side of the accumulator 64, exceeds a set pressure level.

The hydraulic control valve device 38 includes individual hydraulic valve devices 70, 71, 72, 73 provided for the respective brake cylinders 20, 21, 22, 23. Each of the individual hydraulic valve devices 70-73 includes a pressure-increasing linear valve 80, 81, 82, 83 provided, in the pump line 36, as a solenoid-operated control valve for increasing the fluid pressure, and a pressure-reducing linear valve 90, 91, 92, 93 provided, in a pressure reduction line 86, as a solenoid-operated control valve for reducing the fluid pressure. The pressure reduction line 86 connects the brake cylinders 20-23 with the master reservoir 62. The fluid pressures of the brake cylinders 20-23 for the front-left, front-right, rear-left and rear-right wheels, respectively, are individually and independently controllable through control of the pressure-increasing linear valves 80-83 and the pressure-reducing linear valves 90-93. The pressure-increasing linear valves 80-83 provided for the respective four wheels and the pressure-reducing linear valves 90, 91 provided for the front, left and right wheels are of normally closed type, namely, each of these valves is normally in the closed state while no current is applied to a coil 100. On the other hand, the pressure-reducing linear valves 92, 93 provided for the rear, left and right wheels are of normally open type, namely, each of these values is the open state while no current is applied to a coil 102.

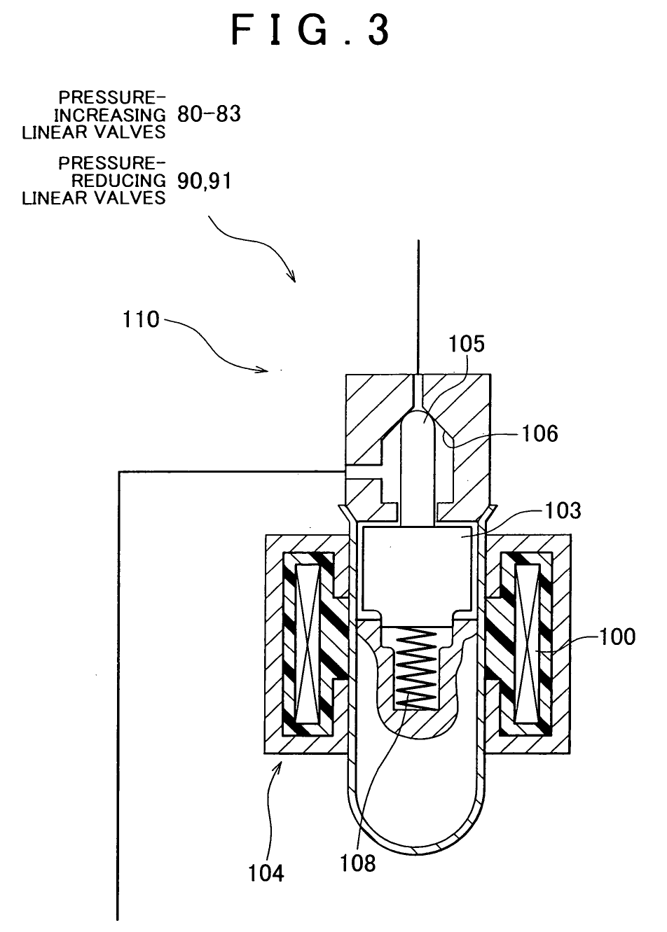

FIG. 3 shows one example of the pressure-increasing linear valves 80-83 and pressure-reducing linear valves 90, 91. Each of the pressure-increasing linear valves 80-83 and pressure-reducing linear valves 90, 91 includes a solenoid 104 having the coil 100, plunger 103 and so forth, and a seating valve 110 having a valve element 105, a valve seat 106, a spring 108 for urging the valve element 105 in such a direction as to seat the valve element 105 on the valve seat 106, and so forth. When no current is applied to the coil 100, the valve element 105 is in a closed state in which the valve element 105 rests on the valve seat 106 under the bias force Fs of the spring 108. When current is applied to the coil 100, the electromagnetic driving force Fd commensurate with the current is applied to the plunger 103 so as to act on the valve element 105 in such a direction as to bring the element 105 away from the valve seat 106. Also, the differential pressure force Fp corresponding to a difference between the pressures sensed on the upstream and downstream sides of the valve acts on the valve element 105 in such a direction as to bring the element 105 away from the valve seat 106. The position of the valve element 105 relative to the valve seat 106 is determined by the relationship among the electromagnetic driving force Fd, differential pressure force Fp and the bias force Fs of the spring 108.

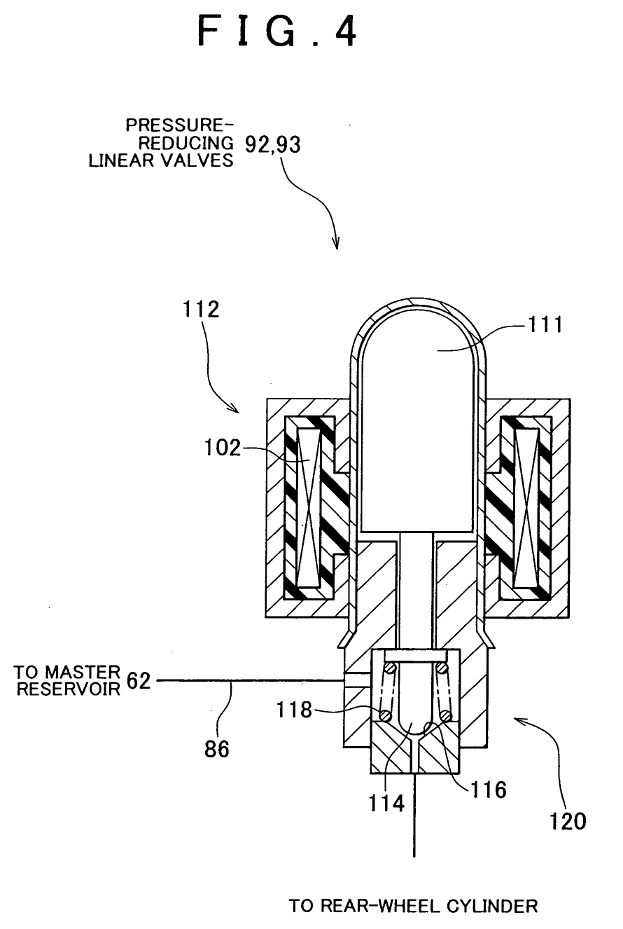

FIG. 4 shows one example of the pressure-reducing linear valves 92, 93 of normally-open type. Each of the pressure-reducing linear valves 92, 93 includes a solenoid 112 having the coil 102, plunger 111 and so forth, and a seating valve 120 having a valve element 114, a valve seat 116, and a spring 118 for urging the valve element 114 in such a direction as to bring the element 114 away from the valve seat 116, and so forth. The pressure-reducing linear valves 92, 93 are located between the brake cylinders 22, 23 for the rear, left and right wheels and the reservoir 62, such that the differential pressure force Fp corresponding to a difference in pressure between the brake cylinders 22, 23 and the reservoir 62 is applied to the valve element 114. When no current is applied to the coil 102, the valve element 114 is in an open state in which the valve element 114 is spaced apart from the valve seat 116 under the differential pressure force Fp and the bias force Fs of the spring 118. When current is applied to the coil 102, the electromagnetic driving force Fd commensurate with the current is applied to the valve element 114 in such a direction as to seat the valve element 114 on the valve seat 116. The position of the valve element 114 relative to the valve seat 116 is determined by the relationship among the bias force Fs of the spring 118, the differential pressure force Fp and the electromagnetic driving force Fd. In the present embodiment, the solenoids 104 of the pressure-increasing linear valves 80-83 and pressure-reducing linear valves 90, 91, the solenoids 112 of the pressure-reducing linear valves 92, 93 and others constitute a hydraulic actuator capable of controlling the fluid pressures of the corresponding brake cylinders.

Referring back to FIG. 2, a stroke simulator device 120 is provided in the master line 26. The stroke simulator device 120 includes a stroke simulator 122 and a simulator switching valve 124 of normally-closed type. By opening and closing the simulator switching valve 124, the stroke simulator 122 is switched between a connected state in which the simulator 122 communicates with the master cylinder 12 and a shutoff state in which the simulator 122 is shut off from the master cylinder 12. In the present embodiment, the simulator switching valve 124 is placed in the open state in a condition in which the hydraulic brakes 16-19 are operated by the working fluid fed from the pump device 14, and is placed in the closed state in a condition in which the hydraulic brakes 16, 17 are operated by the working fluid fed from the master cylinder 12.

The hydraulic brake system as described above is controlled according to commands generated by a brake ECU 200 as shown in FIG. 2. The brake ECU 200 consists mainly of a computer, which includes an execution unit 202, a memory unit 204, an input and output unit 206 and other components. To the input and output unit 206 are connected a stroke sensor 210, a master cylinder pressure sensor 214, brake cylinder pressure sensors 216, wheel speed sensors 218, a hydraulic source pressure sensor 220, a working fluid temperature acquiring device 222 for acquiring the temperature of the working fluid, a running state acquiring device 224 for acquiring the running state of the vehicle, and so forth. In addition, the input and output unit 206 is connected, via switching circuits (not shown), to the coils 100 of the pressure-increasing linear valves 80-83 and pressure-reducing linear valves 90, 91, the coils 102 of the pressure-reducing linear valves 92, 93 and respective coils of the master shutoff valves 29, 30 and simulator control valve 124. The input and output unit 206 is also connected, via a driving circuit (not shown), to the pump motor 58.

The working fluid temperature acquiring device 222 may include a working fluid temperature sensor that directly senses the temperature of the working fluid, or may include an ambient air temperature sensor that senses the temperature of the ambient air, which enables the device 222 to determine that the working fluid temperature is lower than a set value when the ambient air temperature is lower than a set value. In this sense, the temperature of the working fluid may be considered as a physical quantity that represents the environment in which the vehicle is placed. The running state acquiring device 224 acquires the vehicle running state by sensing the running speed of the vehicle and detecting the turning condition of the vehicle, and includes a yaw rate sensor or a steering angle sensor, a vehicle speed sensor, and so forth. In the present embodiment, the state of the braking operation, which is used when determining a control gain as described later, is determined based on a sensed value of the master cylinder pressure sensor 214.

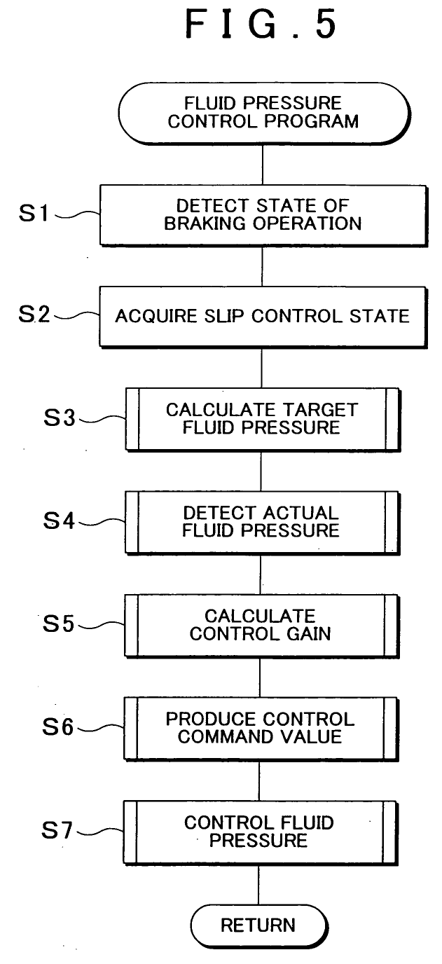

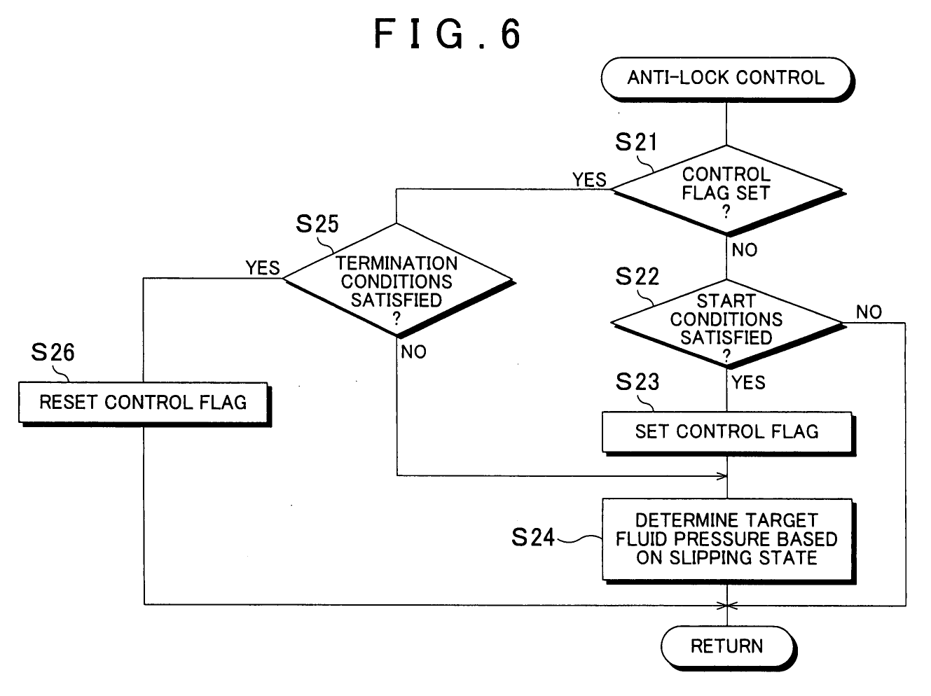

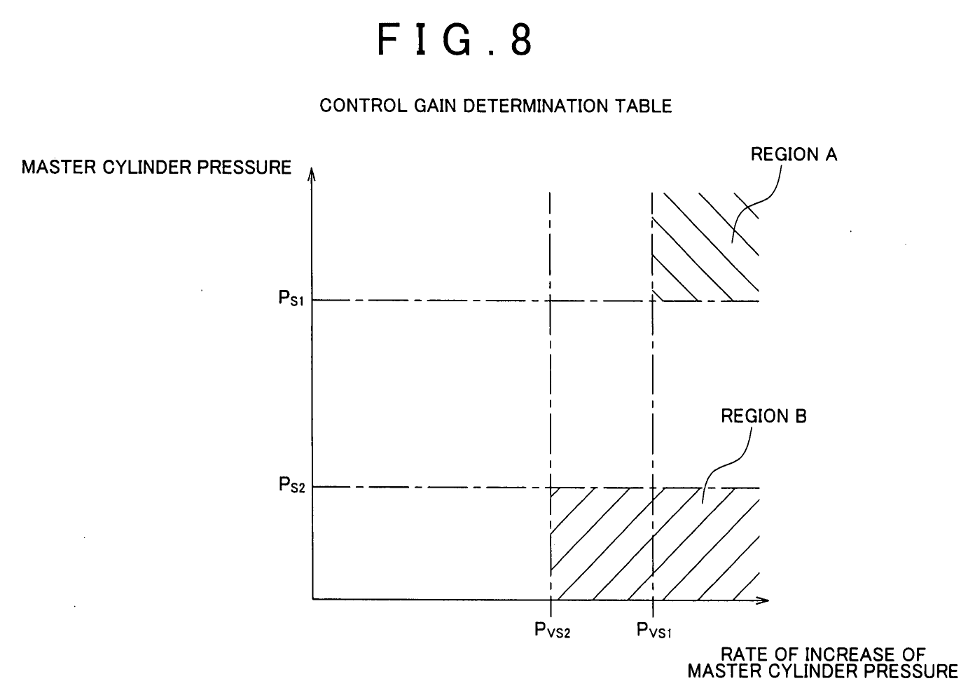

The memory unit 204 of the brake ECU 200 stores a fluid pressure control program illustrated in the flow chart of FIG. 5, an anti-lock control program illustrated in the flow chart of FIG. 6, a table presented in the form of the map of FIG. 8 for determining a control gain, and other data and programs.

The operation of the hydraulic brake system constructed as described above will be now described. In a condition where the master shutoff valves 29, 30 are in the shutoff states, the amount of current supplied to each of the coils 100, 102 of the pressure-increasing linear valves 80-83 and pressure-reducing linear valves 90-93 is controlled so that the actual fluid pressures of the respective brake cylinders 20-23 for the front-left, front-right, rear-left and rear-right wheels approach respective target values (target fluid pressures).

When a brake is normally applied (with no slip control performed), the target values of the brake cylinder pressures are determined based on the state of the operation of the brake pedal 10 by the vehicle operator. In this case, the required braking force is determined based on at least one of the stroke of the brake pedal 10 operated and the operating force applied to the brake pedal 10 (which corresponds to the master cylinder pressure), and the target values are determined in accordance with the required braking force. The target fluid pressures of the brake cylinders 20-23 for the respective wheels may be set to the same level. Alternatively, the target fluid pressures of the brake cylinders 20, 21 for the front, left and right wheels may be set to the same level while the target fluid pressures of the brake cylinders 22, 23 for the rear, left and right wheels may be set to the same level. In the latter case, the proportion between the target fluid pressure for the front left and right wheels and the target fluid pressure for the rear left and right wheels may be determined according to the distribution line of the front and rear braking forces.

During anti-lock control, the target fluid pressures of the brake cylinders 20-23 are respectively determined so that the slipping state of each wheel to which a brake is being applied matches the coefficient of friction of the road surface. During traction control, the target fluid pressures are determined so that the slipping state of each wheel that is being driven matches the coefficient of friction of the road surface. During vehicle stability control, the target fluid pressures are determined so that the lateral slipping state of each wheel matches the coefficient of friction of the road surface. When any of the anti-lock control, traction control and vehicle stability control is performed, a slip control flag is set.

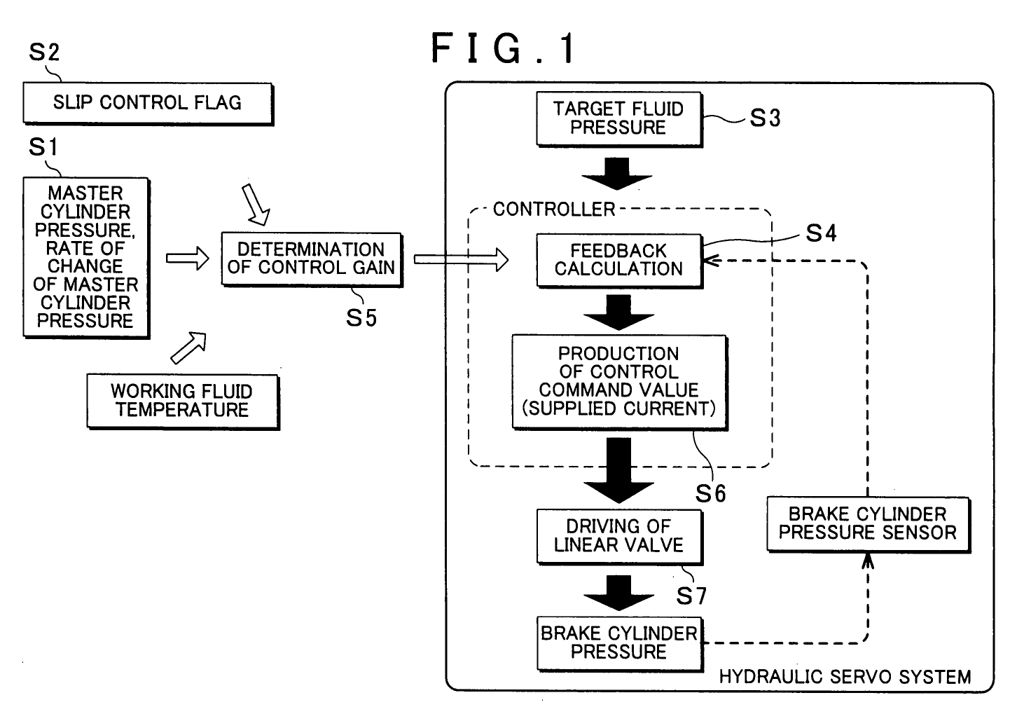

The fluid pressure control program illustrated in the flow chart of FIG. 5 is executed at intervals of a predetermined time. The execution of the fluid pressure control program is schematically illustrated in FIG. 1.

In step S1, the state of a braking operation, such as the stroke of the brake pedal 10 operated and the master cylinder pressure, is detected. In step S2, the state of slip control for each wheel is acquired. In step S3, the target fluid pressures of the brake cylinders are determined based on the states of the braking operation and slip control. In the present embodiment, the target fluid pressures are determined through execution of a suitable slip control program during slip control as described above, and are determined based on the state of the braking operation while no slip control is performed (i.e., during apply of normal brakes). Subsequently, the actual fluid pressures of the brake cylinders 20-23 are respectively detected in step S4, and control gains G are determined in step S5. In step S6, a control command value I for each of the valves to be controlled is produced based on the target fluid pressure, the actual fluid pressure, the control gains and others.

With regard to the pressure-increasing linear valves 80-83, for example, a control command value I may be calculated according to the following expression: I=GP·e+GD·(de/dt)+GI·Σe, where e (=Pref−Pwc) is a deviation of the actual fluid pressure Pwc from the target fluid pressure. Pref, and de/dt and Σe are differential and integral values of the deviation, respectively. Namely, the control command value I may be obtained as the sum of the product of the deviation e and control gain GP, the product of its differential value de/dt and control gain GD and the product of its integral value Σe and control gain GI. Then, electric current corresponding to the control command value I thus obtained is supplied to the coil 100 of the valve to be controlled. Thus, in the present embodiment, the brake cylinder pressures are feedback-controlled so that the actual fluid pressures Pwc approach the target fluid pressures Pref.

The anti-lock control program illustrated in the flow chart of FIG. 6 is executed at intervals of a predetermined time. In step S21, it is determined whether an anti-lock control flag (one of the slip control flags) that indicates that anti-lock control is being performed is set. If the control flag is not set, it is determined in step S22 whether anti-lock control start conditions (i.e., conditions for starting anti-lock control) are satisfied. If the start conditions are satisfied, a slip control flag is set in step S23, and the target fluid pressures are determined in step S24. In the present embodiment, it is determined that the anti-lock start conditions are satisfied when a parameter or parameters representing the slipping state of the wheel(s) to which a brake is being applied exceeds a predetermined value or values. The target fluid pressures are determined based on the slipping state of the wheel(s), so that the actual slipping state is brought into the optimum state determined by the coefficient of friction of the road surface.

If it is determined in step S21 that the slip control flag (i.e., anti-lock control flag) is set, it is determined in step S25 whether anti-lock control termination conditions are satisfied. If the anti-lock termination conditions are not satisfied, anti-lock control continues to be performed in step S24, and the target fluid pressures are determined based on the slipping state of the wheels. When the anti-lock control termination conditions are satisfied, for example, when the running speed of the vehicle becomes equal to or lower than a set speed, the slip amount becomes equal to or smaller than a set amount, and other conditions are satisfied, the slip control flag is reset in step S26. The traction control and the vehicle stability control are also implemented according to similar control programs. Flow charts illustrating these control programs are not provided herein.

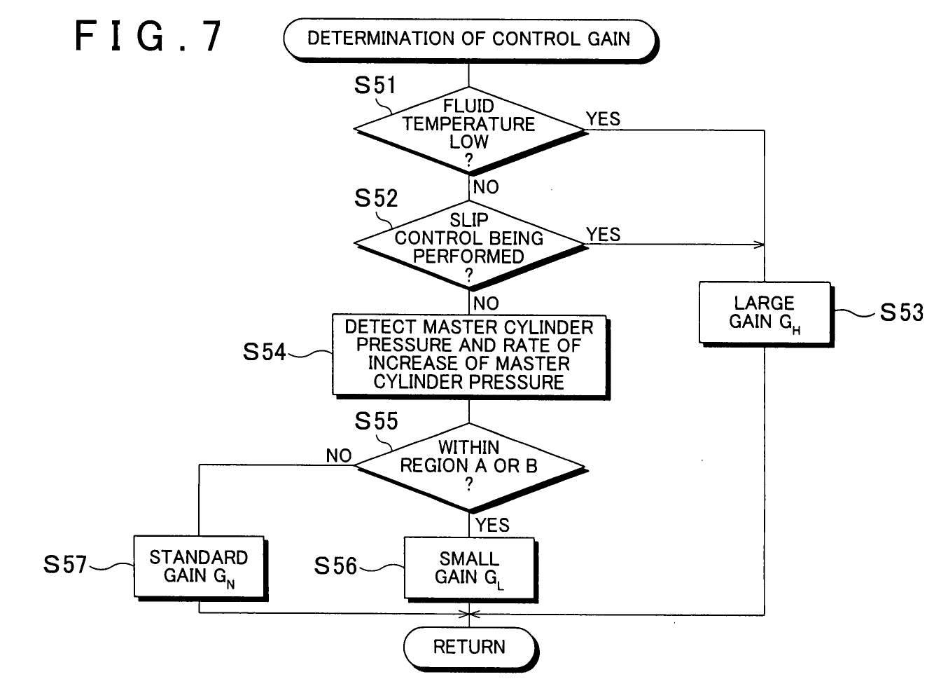

The control gains are determined in step S5 of the fluid pressure control program of FIG. 5 by executing a control routine illustrated in the flow chart of FIG. 7. While three control gains GP, GD, GI are used for determining the control command value I as described above with respect to the pressure-increasing linear valves 80-83, these gains are assumed to be determined according to the same rules in the present embodiment. In the following, therefore, the manner of determining the control gains will be described without distinguishing one gain from another.

Referring to FIG. 7, it is determined in step 551 whether the temperature of the working fluid is equal to or lower than a set temperature (which may be set, for example, to a value in the vicinity of −20° C.). In step S52, it is determined whether the slip control flag is set or reset. The set temperature as indicated above is set to a temperature below which the control delay becomes undesirably large due to the increase of the viscosity of the working fluid with the reduction in the fluid temperature. If the working fluid temperature is equal to or lower than the set temperature, or if slip control is being performed, the control gain is set to a high value GH in step S53. If the working fluid temperature is higher than the set temperature AND no slip control is being performed, the master cylinder pressure is detected and the rate of increase (speed of increase) of the master cylinder pressure is obtained in step S54. It is then determined in step S55 whether the master cylinder pressure and the rate of increase of the master cylinder pressure are within either of REGION A and REGION B as indicated in FIG. 8. An affirmative decision (YES) is obtained in step S55 when the master cylinder pressure Pmc is equal to or higher than a first set pressure Ps1 AND the rate Pvmc of increase of the master cylinder pressure is equal to or higher than a first set rate Pvs1 (i.e., when Pmc and Pvmc are within REGION A), or when the master cylinder pressure Pmc is equal to or lower than a second set pressure Ps2 that is lower than the first set pressure Ps1 AND the rate Pvmc of increase of the master cylinder pressure is equal to or higher than a second set rate Pvs2 that is lower than the first set rate Pvs1 (i.e., when Pmc and Pvmc are within REGION B). If Pmc and Pvmc are within REGION A or B, the control gain is set to a small value GL in step S56. If Pmc and Pvmc are not within REGION A and REGION B, the control gain is set to a standard value GN in step S57. The first set pressure Ps1 and the first set rate Pvs1 are set to respective values at or above which anti-lock control is highly likely to be started in the vehicle having a supple suspension. The second set rate Pvs2 is set to a value at or above which large noise is likely to be produced due to squatting on the front-wheel side of the vehicle upon apply of a brake. The second set pressure Ps2 is set to a value at or below which no problem arises even if the control gain is set to a small value. Each of the control gains GH, GN and GL is set in advance to different values with respect to the control gains GP, GD and GI.

The control gains are set to large values GH when the working fluid temperature is equal to or lower than the set temperature as described above, and, therefore, control delay due to high viscosity of the working fluid can be reduced. Since the control gains are also set to large values GH during slip control, the brake cylinder pressure for each wheel can be quickly increased or reduced in accordance with the control command values, and the slipping state of the wheel can be quickly made close to an appropriate state.

Furthermore, the control gains are set to small values GL when the master cylinder pressure is equal to or higher than the first set pressure Ps1 AND the rate of increase of the master cylinder pressure is equal to or higher than the first set rate Pvs1, and, therefore, anti-lock control is unlikely to be initiated even in the vehicle having a supple suspension that causes slow movements of the load in the vehicle. Since the control gains are also set to small values GL when the master cylinder pressure is lower than the second set pressure Ps2 AND the rate of its increase is equal to or higher than the second set rate Pvs2, the noise produced due to squatting of the vehicle body on the front-wheel side thereof can be reduced or eliminated while the influence of control delay is reduced.

In the present embodiment, a portion of the brake ECU 200 which stores the fluid pressure control program of FIG. 5, a portion of the ECU 200 which executes the same program and other portions constitute an actuator controller, of which a portion that stores step S5, a portion that executes step S5 and other portions constitute a control gain determining unit. A portion of the control gain determining unit which stores steps S51, S53 of FIG. 7, a portion thereof which executes these steps and other portions constitute a temperature-dependent gain determining unit that makes the control gain larger when the working fluid has a low temperature. A portion of the control gain determining unit which stores steps S52, S53 of FIG. 7, a portion thereof which executes these steps and other portions constitute a slip-dependent gain determining unit that makes the control gain larger during slip control. A portion of the control gain determining unit which stores steps S54-S57 of FIG. 7, a portion thereof which executes these steps and other portions constitute an operation-dependent control gain determining unit that determines a control gain according to the state of the braking operation. The operation-dependent control gain determining unit includes a first gain determining unit that determines a control gain in accordance with the operating force, and a second gain determining unit that determines a control gain in accordance with the operating speed.

While the state of the braking operation used for determining the control gain is acquired based on the master cylinder pressure in the illustrated embodiment, the state of the braking operation may be acquired on the basis of the stroke of the brake pedal 10 operated, or on the basis of the operating force applied to the brake pedal 10, which force is sensed by an operating force sensor. While the control gain is set to a fixed value selected from predetermined fixed values in the illustrated embodiment, the value of the control gain may be determined depending upon the temperature of the working fluid, or may be determined depending upon the level of the master cylinder pressure, or may be determined depending upon the rate of increase of the master cylinder pressure. While the control gain is set to the same value in both of the case where the master cylinder pressure Pmc and the rate Pvmc of its increase are within REGION A and the case where Pmc and Pvmc are within REGION B in the illustrated embodiment, the control gain may be set to different values that are respectively determined with respect to the case where Pmc and Pvmc are within REGION A and the case where Pmc and Pvmc are within REGION B. Furthermore, it is not essential that all of the gains GP, GD, GI be determined in the manner as described above in the illustrated embodiment. Rather, at least one of the gains GP, GD, GI may be determined in the manner as described above. While the hydraulic brake system of the illustrated embodiment is adapted to perform anti-lock control, traction control and vehicle stability control, the hydraulic brake system to which the invention is applied may perform at least one of these controls.

While the control command value I is determined based on the deviation of the actual fluid pressure from the target fluid pressure and the differential and integral values of the deviation in the illustrated embodiment, the control command value I is not necessarily determined in this manner. For example, the control command value may be obtained by multiplying the deviation by the control gain. While the hydraulic brake system is installed on the vehicle of the type having a supple suspension and a large empty vehicle weight in the illustrated embodiment, the brake system may be installed on a vehicle of a type having a stiff suspension or a vehicle of a type having a small empty vehicle weight. In this case, it is not necessary to execute steps S54-S56 in the program of FIG. 7 since the necessity of changing the control gain based on the state of the braking operation is reduced. With steps S54-S56 omitted, the control gain is set to the standard value GN when the temperature of the working fluid is higher than the set temperature and no slip control is being performed.

While control of electric current applied to the pressure-increasing linear valves 80-83 has been explained above in the illustrated embodiment, similar control may be performed so as to control current applied to the pressure-reducing linear valves 90, 91. In this case, the control command value I is obtained as the sum of the product of the absolute value |e| of the deviation and the control gain GP, the product of the differential value d|e|/dt of the absolute value of the deviation and the control gain GD, and the product of the integral value Σ|e| of the absolute value of the deviation and the control gain GI, and current corresponding to the thus obtained control command value I is applied to the pressure-reducing linear valve 90, 91. Furthermore, when control of current applied to the pressure-reducing linear valves 92, 93 of normally-open type is performed, the amount of current applied may be reduced, for example, in accordance with the control command value I.

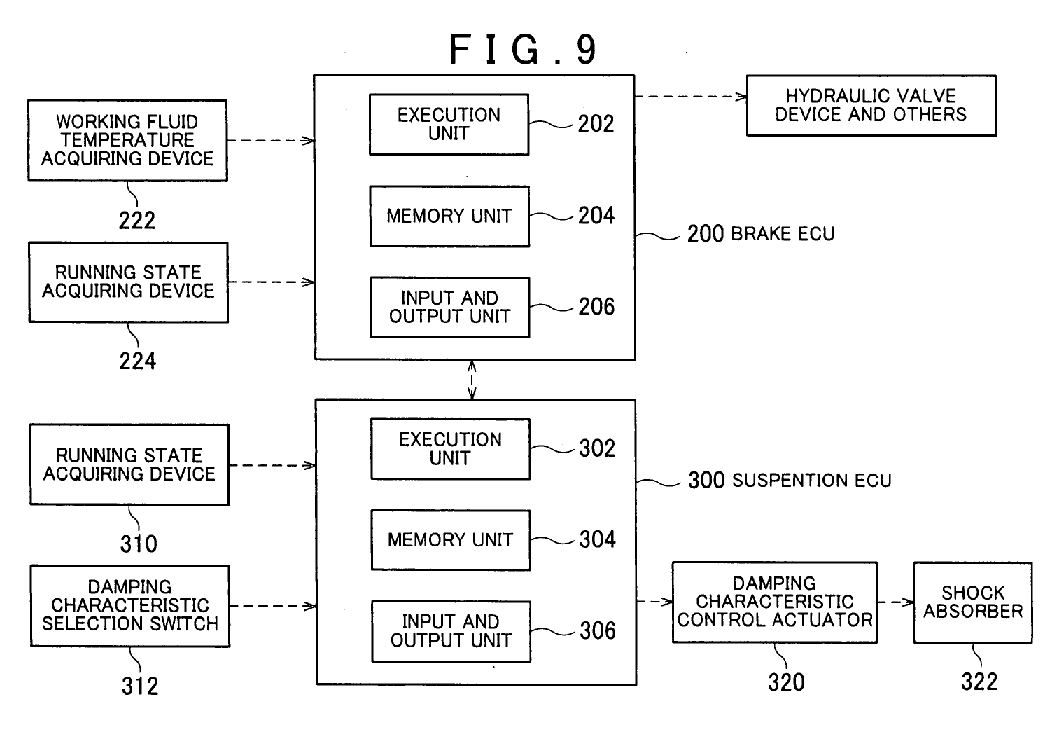

The hydraulic brake system to which the invention is applied may be installed on a vehicle in which the stiffness of its suspension can be changed: for example, the damping characteristics of shock absorbers mounted between wheel support devices for supporting the wheels and vehicle body members can be switched between a hard condition and a soft condition. An example of the hydraulic brake system installed on this type of vehicle is illustrated in FIG. 9.

In the embodiment of FIG. 9, a suspension ECU 300 is connected to the brake ECU 200, and information is communicated between the ECU 200 and the ECU 300. The suspension ECU 300 consists mainly of a computer including an execution unit 302, a memory unit 304, an input and output unit 306, and so forth. To the input and output unit 306 are connected a running state acquiring device 310 that acquires the running state of the vehicle, a damping characteristic selection switch 312, and others. The damping characteristic selection switch 312 is operable by the vehicle operator, and can be switched between a soft mode in which the damping coefficient is smaller than a set value, and a hard mode in which the damping coefficient is equal to or larger than the set value. A damping characteristic control actuator 320 is connected to the input and output unit 306, and is adapted to control the damping characteristic of a shock absorber 322 provided between the wheel support device and the vehicle body for each of the front, right and left wheels and rear, right and left wheels. In the present embodiment, the damping characteristic control actuator 320 includes an electric motor for changing the opening of a control valve (not shown) provided in the shock absorber 322. The suspension ECU 300 controls the damping characteristic control actuator 320 according to a command of the damping characteristic selection switch 312, and also control the actuator 320 based on the vehicle running state detected by the running state acquiring device 310.

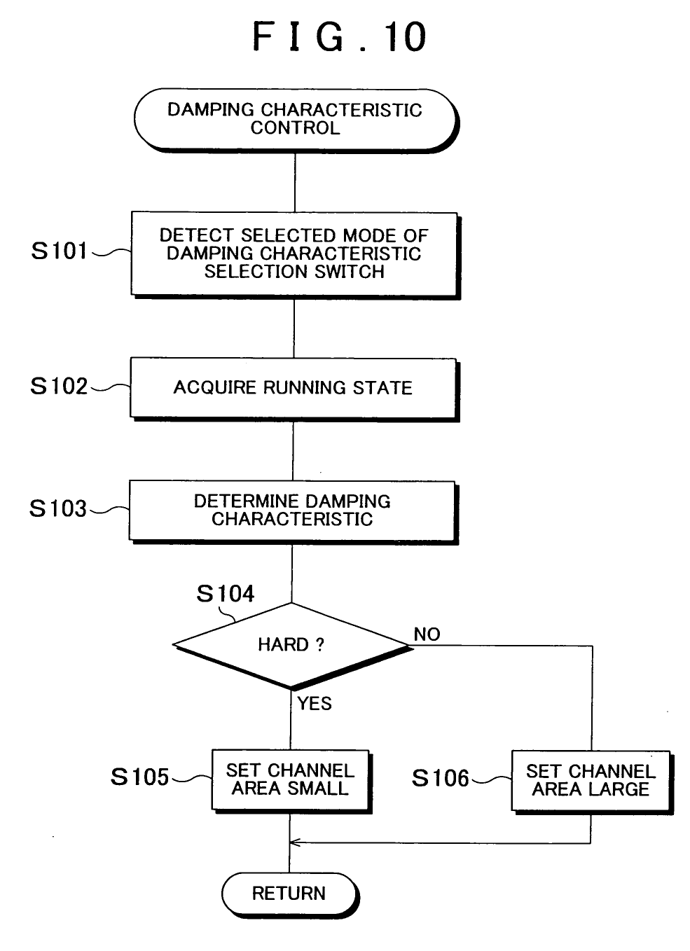

In the suspension ECU 300, a damping characteristic control program illustrated in the flow chart of FIG. 10 is executed at intervals of a predetermined time. Initially, the selected mode of the damping characteristic selection switch 322 is detected in step S101, and the running state of the vehicle is acquired in step S102. It is then determined in step S103 whether the damping characteristic is controlled to be hard or soft based on the information obtained in steps S101 and S102. For example, the damping characteristic may be controlled according to the command of the switch 322 during normal running of the vehicle, and may be controlled based on the running state of the vehicle when a change in rolling or a change in pitching is large. To make the damping characteristic hard, the damping characteristic control actuator 320 is controlled so as to reduce the cross-sectional area of a flow channel that communicates with the upper chamber and lower chamber of the shock absorber 322 in step S105. To make the damping characteristic soft, the control actuator 320 is controlled so as to increase the cross-sectional area of the flow channel.

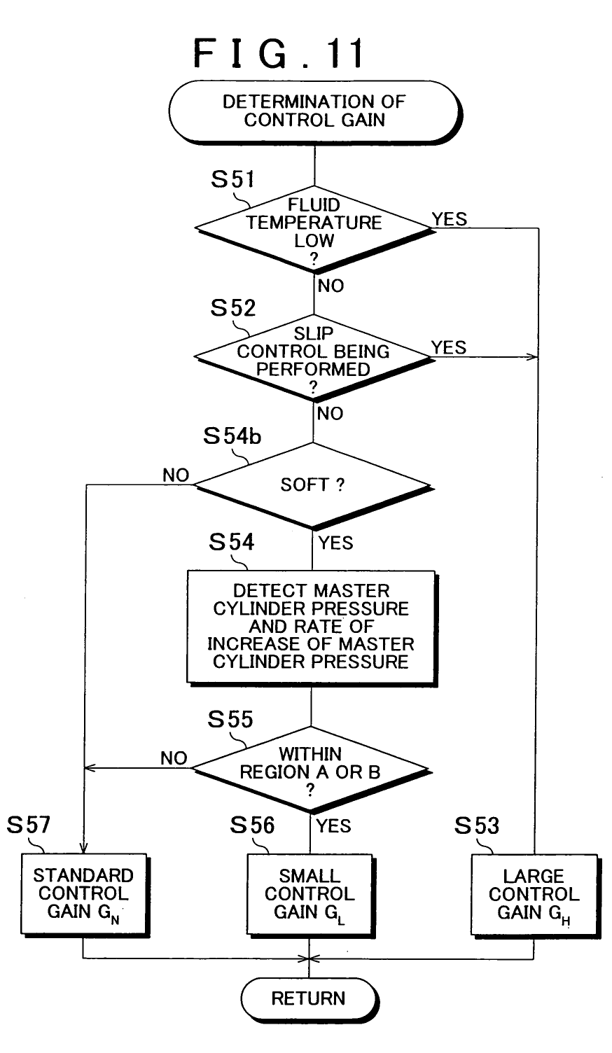

The brake ECU 200 performs the fluid pressure control program illustrated in the flow chart of FIG. 5 in the same manner as in the previous embodiment, except that determination of the control gain is performed according to a routine illustrated in the flow chart of FIG. 11.

When the temperature of the working fluid is higher than the set temperature and no slip control is being performed, it is determined in step S54b, through communication with the suspension ECU 300, whether the damping characteristic of the shock absorber for each wheel is hard or soft. If the damping characteristic is hard, the control gain is set to the standard value GN in step S57. If the damping characteristic is soft, step S54 and subsequent steps are executed in the same manner as in the previous embodiment. Thus, in the present embodiment, the control gain is set to the standard value GN when the suspension is made stiff (when the damping characteristic is made hard), and is determined based on the state of the braking operation when the suspension is made supple (when the damping characteristic is made soft). With this arrangement, when the suspension is made supple, changes in the vehicle posture can be suppressed, and anti-lock control is less likely to be initiated. In the present embodiment, a portion of the brake ECU 200 which stores step S54b, a portion thereof which executes step S54b and other portions constitute a gain determination process changing unit that changes the process of determination of the control gain depending upon the stiffness of the suspension. With the characteristics of the vehicle varying with time, the modulus of elasticity of a suspension spring provided, along with the shock absorber, between the wheel support device and the vehicle body member may be reduced, and the suspension may be made supple. In this case, the control gain may be determined based on the state of the braking operation.

While some embodiments of the invention have been described above, for the illustrative purpose only, it is to be understood that the invention is not limited to the details of the illustrated embodiments, but may be embodied with various changes, modifications or improvements, which may occur to those skilled in the art without departing from the spirit and scope of the invention.

What is claimed is:

1. A brake fluid pressure control apparatus of a vehicle, comprising:
a hydraulic brake having a brake cylinder for a wheel, the brake cylinder having a fluid pressure that is controlled so as to retard the rotation of the wheel;
a hydraulic actuator capable of controlling the fluid pressure of the brake cylinder; and
an actuator controller that feedback-controls the hydraulic actuator so that an actual fluid pressure of the brake cylinder approaches a target fluid pressure determined in accordance with a braking requirement, wherein
the actuator controller comprises a control gain determining unit that determines a control gain used when determining a control command value to be sent to the hydraulic actuator, based on at least one of a temperature of a working fluid and a slipping state of the wheel.

2. The brake fluid pressure control apparatus according to claim 1, wherein the control gain determining unit comprises a temperature-dependent gain determining unit that determines the control gain such that a value of the control gain determined when the temperature of the working fluid is low is larger than that of the control gain determined when the temperature of the working fluid is high.

3. The brake fluid pressure control apparatus according to claim 1, wherein the control gain determining unit comprises a temperature-dependent gain determining unit that determines the control gain such that a value of the control gain determined when the temperature of the working fluid is equal to or lower than a reference level is larger than that of the control gain determined when the temperature of the working fluid is higher than the reference level.

4. The brake fluid pressure control apparatus according to claim 1, wherein the control gain determining unit comprises a slip-dependent gain determining unit that determines the control gain such that a value of the control gain determined when slip control is being performed on the wheel is larger than that of the control gain determined when no slip control is being performed on the wheel.

5. The brake fluid pressure control apparatus according to claim 1, wherein the actuator controller further comprises an operation-dependent control gain determining unit that determines the control gain based on a state of an operation of a braking member by a vehicle operator.

6. The brake fluid pressure control apparatus according to claim 5, wherein the operation-dependent control gain determining unit comprises at least one of:
a first gain determining unit that determines the control gain such that a value of the control gain determined when an operating force as the state of the operation of the braking member is large is smaller than that of the control gain determined when the operating force is small; and
a second gain determining unit that determines the control gain such that a value of the control gain determined when an operating speed as the state of the operation of the braking member is high is smaller than that of the control gain determined when the operating speed is low.

7. The brake fluid pressure control apparatus according to claim 5, wherein the operation-dependent control gain determining unit comprises at least one of:
a first gain determining unit that determines the control gain such that a value of the control gain determined when an operating force as the state of the operation of the braking member is equal to or larger than a reference force is smaller than that of the control gain determined when the operating force is smaller than the reference force; and
a second gain determining unit that determines the control gain such that a value of the control gain determined when an operating speed as the state of the operation of the braking member is equal to or higher than a reference speed is smaller than that of the control gain determined when the operating speed is lower than the reference speed.

8. The brake fluid pressure control apparatus according to claim 1, wherein the actuator controller further comprises a gain determination process changing unit that changes a process of determination of the control gain depending upon whether a suspension of the vehicle is stiff or supple.

9. A brake fluid pressure control method for a vehicle including a hydraulic brake having a brake cylinder for a wheel, the brake cylinder having a fluid pressure that is controlled so as to retard the rotation of the wheel, and a hydraulic actuator capable of controlling the fluid pressure of the brake cylinder, comprising:
feedback-controlling the hydraulic actuator so that an actual fluid pressure of the brake cylinder approaches a target fluid pressure determined in accordance with a braking requirement; and
determining a control gain used when determining a control command value to be sent to the hydraulic actuator, based on at least one of a temperature of a working fluid and a slipping state of the wheel.

10. The brake fluid pressure control method according to claim 9, wherein the control gain is determined such that a value of the control gain determined when the temperature of the working fluid is low is larger than that of the control gain determined when the temperature of the working fluid is high.

11. The brake fluid pressure control method according to claim 9, wherein the control gain is determined such that a value of the control gain determined when the temperature of the working fluid is equal to or lower than a reference level is larger than that of the control gain determined when the temperature of the working fluid is higher than the reference level.

12. The brake fluid pressure control method according to claim 9, wherein the control gain is determined such that a value of the control gain determined when slip control is being performed on the wheel is larger than that of the control gain determined when no slip control is being performed on the wheel.

13. The brake fluid pressure control method according to claim 9, wherein the control gain is determined based on a state of an operation of a braking member by a vehicle operator.

14. The brake fluid pressure control method according to claim 13, wherein the determination of the control gain comprises at least one of:
the control gain is determined such that a value of the control gain determined when an operating force as the state of the operation of the braking member is large is smaller than that of the control gain determined when the operating force is small; and
the control gain is determined such that a value of the control gain determined when an operating speed as the state of the operation of the braking member is high is smaller than that of the control gain determined when the operating speed is low.

15. The brake fluid pressure control method according to claim 13, wherein the determination of the control gain comprises at least one of:
the control gain is determined such that a value of the control gain determined when an operating force as the state of the operation of the braking member is equal to or larger than a reference force is smaller than that of the control gain determined when the operating force is smaller than the reference force; and
the control gain is determined such that a value of the control gain determined when an operating speed as the state of the operation of the braking member is equal to or higher than a reference speed is smaller than that of the control gain determined when the operating speed is lower than the reference speed.

16. The brake fluid pressure control method according to claim 9, wherein a process of determination of the control gain is changed depending upon whether a suspension of the vehicle is stiff or supple.
